(19) United States
(12) Patent Application Publication
(10) Pub. No.: US 2004/0249593 A1
(43) Pub. Date: Dec. 9, 2004

(54) Pressure sensitive paint

(76) Inventors: Michael Dunleavy, Filton (GB); Alan G Davies, Filton (GB); David J Bedwell, Filton (GB)

Correspondence Address: NIXON & VANDERHYE, PC, 1100 N GLEBE ROAD, 8TH FLOOR, ARLINGTON, VA, 22201-4714, US

(21) Appl. No.: 10/491,778

(22) PCT Filed: Jan. 23, 2004
(86) PCT No.: PCT/GB04/00278

(30) Foreign Application Priority Data
Feb. 4, 2003 (GB) 0302489.0

(51) Int. Cl. G06F 19/00

(52) U.S. Cl. 702/98

(57) ABSTRACT

A method of calibrating pressure sensitive paint is provided comprising the steps of: illuminating the paint under a range of pressures and temperatures; measuring the intensity of light emitted by the paint following each illumination thereby measuring decay curves; and performing a curve fit of the decay curves to determine characteristic constants. These constants can then be used to generate a model of decay curves and a polynomial relating pressures and temperatures for ratios of intensities over gated areas of the model decay curves can be calculated. Pressure determination at the calibrated paint can then be performed by illuminating the paint, measuring the intensity of light emitted by the paint over two of the gated areas, determining the ratio of the gated area intensities and finally determining the pressure and/or temperature from the polynomial using the determined ratio of the gated area intensities.

This invention relates to a sensor system using pressure sensitive paint wherein the paint is illuminated and its luminescence is measured to provide information about the pressure and temperature in the environment of the paint. Luminescence is taken to mean fluorescence or phosphorescence.

Pressure sensitive paint contains a luminescing molecule, such that incident light may cause electrons in the molecule to be excited to higher energy levels. This excitation energy may be released as the electron falls back to a lower energy level by emission of one or more photons. This process may be quenched by exposure to oxygen as the presence of oxygen provides an alternative mechanism for energy loss that does not involve light emission. As the emission of light from pressure sensitive paints is dependent on oxygen concentration, pressure sensitive paints may be calibrated to measure oxygen concentrations in fluids or may be calibrated to measure the local pressure of a fluid where the oxygen concentration of that fluid is known. For example, a sensor system using a pressure sensitive paint may be used in blood or ground water analysis or in wind tunnel testing.

For renal and ground water analysis, the end of an optical fibre is coated in a pressure sensitive paint and immersed in blood. Light pulses are passed down the optical fibre to illuminate the pressure sensitive paint and the luminescence of the paint is measured to derive the oxygen concentration of the blood or of the ground water.

For wind tunnel testing, an aerodynamic structure (normally a model of a building or vehicle, an aircraft model being an obvious example) is painted with the pressure sensitive paint and placed in the airflow within a wind tunnel. The model is then illuminated with pulses of light and the resulting luminescence of the pressure sensitive paint measured. As the oxygen concentration in the air is known and fixed, the luminescence gives an indication of the air pressure and hence air flow over the model.

However, there is a major problem with pressure sensitive paints that must be overcome in that the luminescence of the paints is dependent upon both pressure and temperature. Hence, the local temperature of the pressure sensitive paint must also be known if unambiguous pressure information is to be gained.

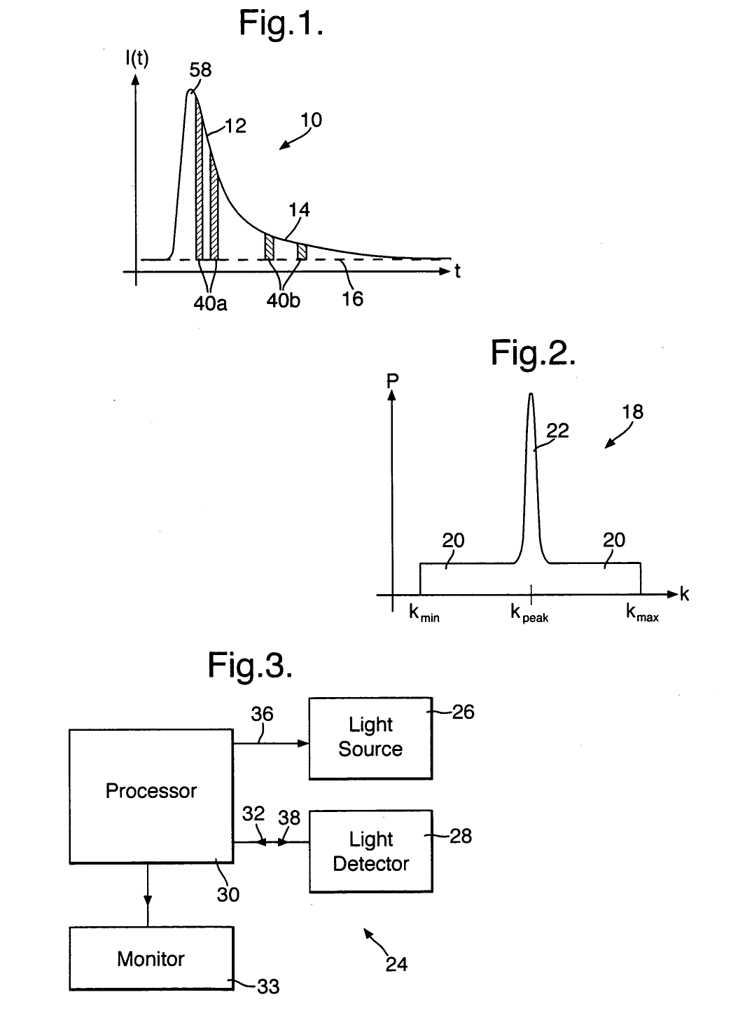

A sensor system using pressure sensitive paint is disclosed in EP-A-0,252,578. The sensor system disclosed in this document is used to measure oxygen concentration in blood using the method described generally above. The pressure sensitive paint is chosen such that it has a relatively long-lived decay rate (i.e. the rate of decay from excited states, be it by luminescence or quenching). The rate of luminescence gradually decreases with time, i.e. it is gradually extinguished as shown in FIG. 1. The decay rate of the pressure sensitive paint is measured by integrating the intensity of light received by a photodetector over two time intervals. The first interval is measured during the extinction of the luminescence and the second interval is measured at the tail of the curve to provide a baseline. The baseline corresponds to any dark current and ambient light in the photodetector and is subtracted from the integrated intensity measured during extinction. The oxygen concentration is derived by comparing the integrated intensity against a formula that includes coefficients reflecting the temperature of the pressure sensitive paint. To solve the equation requires a measurement of the temperature and this is performed using a thermocouple. Hence, in addition to the optical fibre being coated in pressure sensitive paint, the sensor system must also comprise a second sensor at extra expense and complexity. Furthermore, the accuracy of the oxygen concentration determination is reliant upon the accuracy of the thermocouple.

A second way of addressing the temperature-dependency problem is disclosed in EP-A-0,472,243. Here, the pressure sensitive paint further comprises a second type of luminescing molecule that is temperature dependent only. The two types of luminescing molecule are chosen so that they emit light at slightly different wavelengths such that their intensities can be measured separately although, in practice, there is always some overlap. This overlap in conjunction with imperfect optical filtering in detectors can lead to cross-correlation. In principle, the temperature information provided by the second type of molecule allows the pressure information to be extracted from the temperature/pressure information provided by the first type. However, it is thought that this method suffers from, an inherent disadvantage in that the two types of molecule may interact with each other. For example, light emitted by one type of molecule may be absorbed by the other leading to further luminescence and a misrepresentative luminescence decay curve. Furthermore, some temperature-dependent only paints rely on trapping fixed concentrations of oxygen. However, this is impractical to achieve as the oxygen concentration is affected by temperature cycling and changes in permeability in the paint matrix.

From a first aspect, the present invention resides in a method of calibrating pressure sensitive paint comprising the steps of:

(a) illuminating the pressure sensitive paint under a range of pressures and temperatures;

(b) measuring the intensity of light emitted by the pressure sensitive paint following each illumination thereby measuring decay curves; and

(c) performing a curve fit of the decay curves to the general form

$$I ( t ) = a \cdot {ⅇ}^{- {k}_{peak} t} + \frac{b}{t} ( \frac{{ⅇ}^{{k}_{min} t} - {ⅇ}^{{k}_{max} t}}{{k}_{max} - {k}_{min}} )$$

where t is time elapsed and a, b, kₚₑₐₖ, kₘᵢₙ and kₘₐₓ are determined by the curve fit.

In the context of the claims and the corresponding statements of invention, the term ‘pressure’ is intended to mean pressure of oxygen as sensed by the pressure sensitive paint and so includes both local air pressure (e.g. as would be the case for a paint-coated model in a wind tunnel) and also local oxygen concentration (e.g. as would be the case in renal or ground water analysis).

A range of pressures and temperatures may include a plurality of pressures and one temperature, one pressure and a plurality of temperatures or a plurality of pressures and a plurality of temperatures.

When the decay curves are measured, they may be measured continuously (e.g. as a series of points such that the complete decay curve can be traced) or by measuring at selected points or regions along the decay curve.

For the avoidance of doubt, the scope of the invention should not be construed in strict compliance with the equation above. Equivalent forms of the equation are also intended to fall within the scope of the claims. For example, merely rearranging the above equation would yield an equivalent form, as would mere substitution of selected constants and variables. For example, kₘₐₓ could be replaced by the quantity kₚₑₐₖ+c where c is a constant that remains fixed across all decay curves.

Optionally, the method may further comprise the steps of measuring the intensity of light emitted by the pressure sensitive paint prior to illumination to give a background intensity value and subtracting the background intensity value from the decay curve prior to performing the curve fit of step (c). This allows the ambient light or any dark current in the light detector to be subtracted to leave only the light emitted by the pressure sensitive paint in response to the illumination.

Preferably, a simplified form of the equation in step (c) is used during curve fitting, namely

$$I ( t ) = {I}_{0} ( v \cdot {ⅇ}^{- {k}_{peak} t} + \frac{1 - v}{t} ( \frac{{ⅇ}^{{k}_{min} t} - {ⅇ}^{{k}_{max} t}}{{k}_{max} - {k}_{min}} ) )$$

where I₀ is the peak intensity measured and v is determined by the curve fit.

It has been found beneficial to use a temperature range that extends substantially from −20° C. to +50° C. Moreover, we have found illuminating the pressure sensitive paint incrementally over the temperature range in 10° C. steps to be preferable.

Optionally, a plurality of decay curves are measured at each temperature and pressure value and the plurality of decay curves are integrated or averaged prior to curve fitting. This allows better statistics to be collected and helps to remove any fluctuation in operational conditions between one illumination and the next. In a currently preferred embodiment, substantially 500 decay curves are measured at each temperature and pressure value.

Optionally, the method may further comprise the steps of: generating a model of decay curves over the range of pressures and temperatures from the determined values of a, b, kₚₑₐₖ, kₘᵢₙ and kₘₐₓ or v, kₚₑₐₖ, kₘᵢₙ and kₘₐₓ; and calculating a polynomial relating pressures and temperatures for ratios of intensities over gated areas of the model decay curves. This is a convenient way of manipulating the data ready for use in taking pressure measurements from the now-calibrated pressure sensitive paint. It is convenient because a relatively simple polynomial can be stored for reference rather than the entire model of decay curves, something that would require far greater computer memory.

Preferably, the position of the gated areas within the model decay curves are determined with reference to the model of decay curves. Alternatively, the positions of the gated areas may be predetermined. Optionally, a first pair of gated areas are determined to occupy the rapidly-decaying portion of the model decay curves and a second pair of gated areas are determined to occupy the gradually-decaying portion of the model decay curves. A further optional feature is to determine alternative gated area positions for the model decay curves according to different pressure and temperature regimes, thereby forming an alternative polynomial. This allows higher precision calibration and pressure and/or temperature measurement at extreme pressures and/or temperatures. For example, three temperature regimes and one pressure regime may be used, the three temperature regimes corresponding to low temperatures, mid-range temperatures and high temperatures.

From a second aspect, the present invention resides in a method of determining pressure comprising the steps of:

(i) illuminating a pressure sensitive paint calibrated as described above;

(ii) measuring the intensity of light emitted by the pressure sensitive paint following illumination over two of the gated areas;

(iii) determining the ratio of the gated area intensities; and

(iv) determining the pressure and/or temperature from the polynomial using the ratio of the gated area intensities determined in step (iii).

This allows less data collection in that measurements need only be taken for the gated areas and not for the entire decay curves. This reduces the amount of computer memory required to store the data and expedites data processing.

Preferably, the method further comprises the steps of measuring the intensity of light emitted by the pressure sensitive paint prior to the illumination of step (i) to give a background intensity value and subtracting the background intensity value from the measurements of the gated areas prior to determining the ratio of the gated areas in step (iii).

Optionally, intensity measurements are taken and compared against intensity measurements taken during calibration and, if the results are not consistent, a new polynomial is calculated with reference to the new intensity measurements. This allows compensation for any differences in experimental set up that may occur, for example because the pressure sensitive paint was calibrated at a location remote from the pressure measurement location. For example, the pressure sensitive paint may be calibrated at its point of manufacture and then sold to a third party for use in their own wind tunnel test facilities.

Preferably, in step (ii), the light emitted over two pairs of gated areas is measured, in step (iii), ratios of both pairs of gated areas are determined and, in step (iv), the determination is performed using both determined ratios. This is to the benefit of accuracy. Optionally, a first pair of gated areas are determined that occupy the rapidly-decaying part of the decay curve and a second pair of gated areas are determined that occupy the gradually-decaying part of the decay curve.

Optionally, the pressure and/or temperature determined by reference to the polynomial is/are checked against the pressure and temperature regimes and, if the polynomial used does not correspond to the pressure and temperature regime determined, steps (ii), (iii) and (iv) are repeated using the appropriate alternative gated area positions and appropriate alternative polynomial.

One application of the present invention is in illuminating a model coated in pressure sensitive paint that is positioned in a wind tunnel. Preferably, the intensity of light emitted from a plurality of portions of the model are measured and the pressure at each portion is determined. This allows a pressure map of the model's surface to be compiled.

From a third aspect, the present invention resides in a computer program comprising program instructions for causing a computer: to receive data in the form of decay curves from a pressure sensitive paint measurement apparatus, and to perform a curve fit of the decay curves to the general form

$$I ( t ) = a \cdot {ⅇ}^{- {k}_{peak} t} + \frac{b}{t} ( \frac{{ⅇ}^{{k}_{min} t} - {ⅇ}^{{k}_{max} t}}{{k}_{max} - {k}_{min}} )$$

where t is time elapsed and a, b, kₚₑₐₖ, kₘᵢₙ and kₘₐₓ are determined by the curve fit.

Preferably, the computer program further causes the computer to perform the curve fit to a simplified form of the above equation, namely

$$I ( t ) = {I}_{0} ( v \cdot {ⅇ}^{- {k}_{peak} t} + \frac{1 - v}{t} ( \frac{{ⅇ}^{{k}_{min} t} - {ⅇ}^{{k}_{max} t}}{{k}_{max} - {k}_{min}} ) )$$

where I₀ is the peak intensity measured and v is determined by the curve fit.

Optionally, the computer program further causes the computer: to generate a model of decay curves from the determined values of a, b, kₚₑₐₖ, kₘᵢₙ and kₘₐₓ or v, kₚₑₐₖ, kₘᵢₙ and kₘₐₓ; and to calculate a polynomial relating pressures and temperatures for ratios of gated areas of the model decay curves. Preferably, the computer program further causes the computer to determine the position of the gated areas with reference to the model of decay curves. Alternatively, the computer program may assign fixed positions for the gated areas.

Optionally, the computer program may cause the computer: to receive data corresponding to measurements from the gated areas; to determine the ratio of intensities from the gated areas; and to determine the pressure and/or temperature from the polynomial.

The present invention also extends to a carrier having thereon any computer program described above and to a computer when programmed with any of the computer programs described above.

The present invention also extends to a pressure sensitive paint measurement apparatus comprising a light source for illuminating the pressure sensitive paint, a light detector for measuring light emitted by the pressure sensitive paint and the computer described above when programmed to receive data in the form of decay curves from the light detector. Preferably, the light source is a Nd-YAG laser and, optionally, the light detector is an avalanche photodiode. Optionally, the apparatus further comprises an analogue-to-digital converter operable to digitise the data provided by the light detector.

Preferably, the apparatus further comprises a display and wherein the computer is programmed to cause the display to show the determined pressure and/or temperature. Optionally, the apparatus may further comprise a model bearing the pressure sensitive paint and a wind tunnel.

The invention will now be described, by way of example only, by reference to the accompanying drawings in which:

FIG. 1 is a plot of the typical luminescence intensity (I) of the pressure sensitive paint versus time (t);

FIG. 2 is a plot of population (p) versus decay rate (k);

FIG. 3 is a block diagram of a sensor system according to an embodiment of the present invention for use in wind tunnel testing;

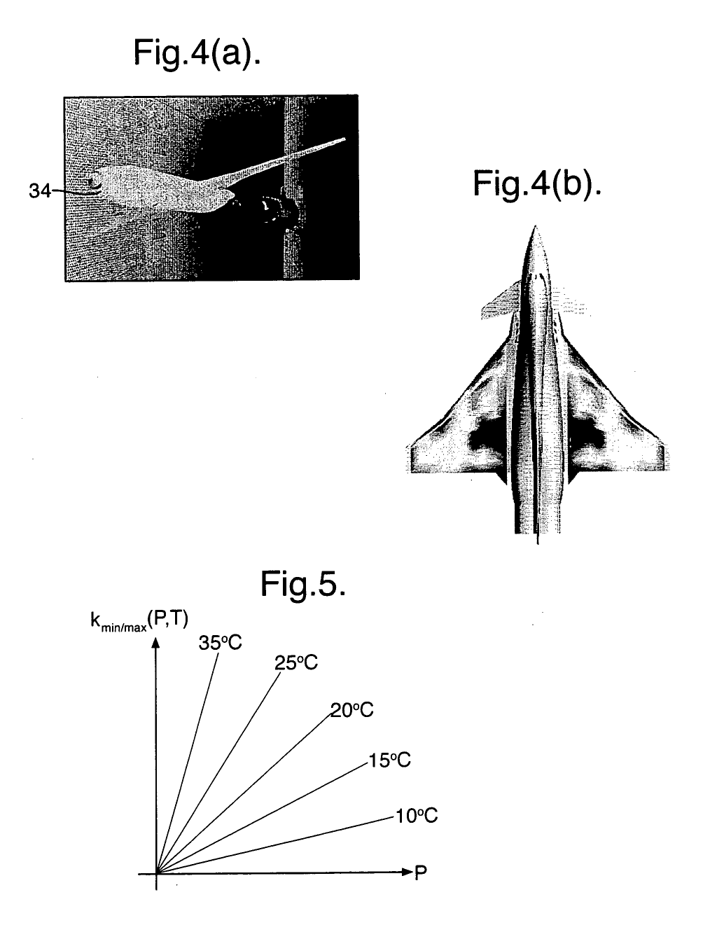

FIG. 4(a) is a perspective view of a pressure sensitive paint-covered model for use in the sensor system of FIG. 3 and FIG. 4(b) is a pressure map of the similar model showing the local pressures across the model's surface at the moment of illumination;

FIG. 5 is a plot of the maximum or minimum decay rate (kₘₐₓ or kₘᵢₙ) versus pressure (P); and

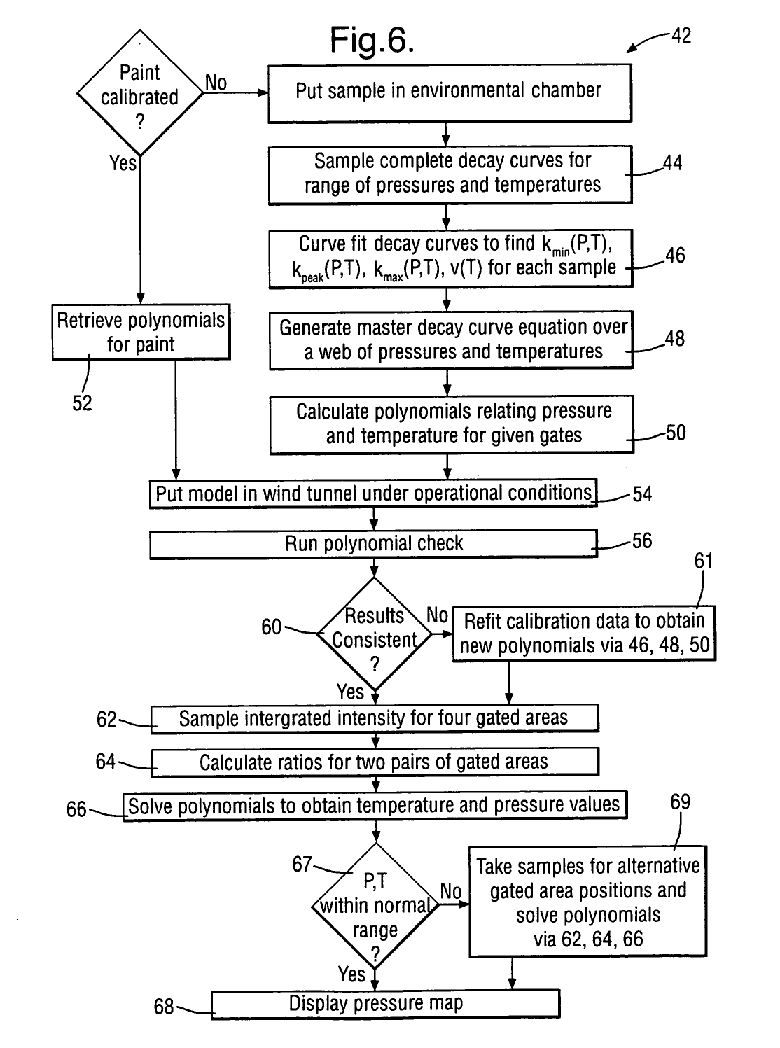

FIG. 6 is a flow diagram of a method of operating the sensor system of FIG. 1.

A luminescence decay curve 10 obtainable with a sensor system according to the present invention is reproduced in FIG. 1 and shows the intensity of light emitted during and after illumination by a flash of light. As can be seen, after the initial rapid increase in intensity (the rise is not instantaneous because of the response time of the light source used), there is extinction of the luminescence intensity that is approximately exponential but that is comprised of two distinct parts. The first part is characterised by a rapid extinction 12 that is followed by a far more gradual extinction 14 that continues to meet asymptotically a baseline 16 corresponding to any dark current and ambient light present in the light detector used. The shape of the decay curve 10 responds both to variations in temperature and in pressure.

We have found that the shape of the luminescence decay curve 10 can be represented satisfactorily by the equation:

$$I ( t ) = a \cdot {ⅇ}^{- {k}_{peak} t} + b {\sum }_{i = min}^{i = max} {ⅇ}^{{k}_{i} t}$$

where a and b are constants, t is time elapsed and k is the decay rate. Assuming a continuous distribution of decay rates allows the second term to be integrated over k to give:

$$I ( t ) = a \cdot {ⅇ}^{- {k}_{peak} t} + \frac{b}{t} ( \frac{{ⅇ}^{{k}_{min} t} - {ⅇ}^{{k}_{max} t}}{{k}_{max} - {k}_{min}} )$$

This can be rewritten to incorporate a parameter v, the proportion of luminophores that decay as kₚₑₐₖ in the paint matrix, as follows:

$$I ( t ) = {I}_{0} ( v \cdot {ⅇ}^{- {k}_{peak} t} + \frac{1 - v}{t} ( \frac{{ⅇ}^{{k}_{min} t} - {ⅇ}^{{k}_{max} t}}{{k}_{max} - {k}_{min}} ) )$$

where I₀ is the peak intensity measured and kₚₑₐₖ, kₘᵢₙ and kₘₐₓ are characteristic decay rates that will be descirbed fully below.

To appreciate the above equation requires consideration of the physical process of light emission and how it is influenced by oxygen quenching. Oxygen present in an air-stream passing over a model acts to stop light emission from luminophores (the luminescing molecules). However, the degree of quenching in any particular area of the model depends on the local environment of the luminophores within the paint matrix because this determines the accessibility of the luminophores to the oxygen. There are a number of possible sites within the paint matrix for the luminophores to occupy that have varying degrees of accessibility for oxygen. For example, migration of oxygen molecules to some luminophore sites may be either particularly easy or particularly difficult whilst, at the molecular scale, the concentration of oxygen is not necessarily homogeneous. This variety of sites leads to a variation in the degree of quenching within an area. The presence of oxygen stops light emission from an otherwise luminophore because of the alternative de-excitation route though loss of energy by quenching. Moreover, this alternative energy-loss mechanism proceeds far more quickly that the light emission route, thereby increasing the decay rate for the sites affected (remembering that decay rate is the rate of decay be it either by light emission or by quenching).

Variation in decay rate can be represented by a population distribution and we have found that the population distribution 18 illustrated in FIG. 2, although simplified, is adequate to realise accurate pressure determination. As will be readily apparent, this population distribution 18 assumes a superposition of a uniform population distribution 20 between a minimum decay rate (kₘᵢₙ) and a maximum decay rate (kₘₐₓ) and a spike 22 centred at kₚₑₐₖ. The position of kₚₑₐₖ relative to kₘᵢₙ and kₘₐₓ varies between different paint compositions. The physical interpretation of the population distribution 18 is as follows. The spike 22 at kₚₑₐₖ represents a proportion of sites and corresponds to a typical open and unhindered site, quite possibly voids in the polymers. The uniform distribution 20 corresponds to a spectrum of sites where oxygen access is hindered due to an intimate relation between luminophore and substrate. For the cases of hindered sites at the kₘᵢₙ end, there is little or no trapped oxygen and this results in low decay rates. At the kₘₐₓ end, the hindered sites tend to trap any oxygen molecules that reach the luminescing molecule resulting in high decay rates. A spectrum of high decay rates results because the degree of hindrance is variable.

The shape of the luminescence decay curve 10 of FIG. 1 can be explained with reference to the equations and physical model discussed above. The initial luminescence at the rapid extinction part 12 of the decay curve 10 is dominated by light emission from unhindered sites, i.e. those comprising the spike 22 at kₚₑₐₖ in the population distribution 18 and sites with trapped oxygen. These sites give rise to the first term in the equation, v.exp(−kₚₑₐₖt) and the fast end of the spectrum of decays. As the initial burst of luminescence diminishes, luminescence from hindered sites that do not trap oxygen progressively dominates such that they form the gradual extinction part 14 of the curve. As explained above, hindered sites that trap oxygen are far less likely to emit light and hence only fractionally contribute to the decay curve 10.

The population distribution 18 is affected both by changes in temperature and pressure. An increase in pressure leads to the greater presence of oxygen due to Henry's Law of Gas Solvation. This, in turn, causes increased quenching with the effect that the population distribution 18 shifts to higher decay rates. As will be appreciated, a decrease in pressure has the opposite effect. Hence, a change in pressure leads to a shift in kₘₐₓ and kₘᵢₙ, but the magnitude and position (kₚₑₐₖ) of the spike 22 relative to the uniform population distribution 20 remains the same due to the linear dependence of all decay rates on pressure. Turning now to the temperature dependency, an increase in temperature leads to higher decay rates and we believe also leads to a conversion of hindered sites into unhindered sites, such as voids in the polymer. Hence kₘₐₓ, kₚₑₐₖ and kₘᵢₙ shift to higher decay rates and the magnitude of the spike 22 increases relative to the uniform distribution 20. The latter effect is reflected in the parameter v that appears in the above equations, this ‘v-factor’ being the proportion of luminophores that occupy voids (sites contributing to kₚₑₐₖ) in the paint matrix. As will be appreciated, the opposite is seen for a decrease in temperature.

We have realised that because the v-factor is dependent on temperature alone, it alone could be used to determine temperature. In practice, kₘₐₓ is not well determined from curve fitting but is fixed in relation to kₚₑₐₖ. However, in principle, pressure and temperature can be determined from curve fitting and generating values of kₘᵢₙ, kₚₑₐₖ and v.

A sensor system 24 for use with pressure sensitive paint in wind tunnel testing will now be described with reference primarily to FIGS. 3, 4a and 6. The sensor system comprises a light source 26, a light detector 28, a processor 30 for controlling the light source 26 and light detector 28 and for collecting and analysing a signal 32 provided by the light detector 28 and a monitor 33 for displaying information. The processor 30 may be, or example, a personal computer suitably programmed to implement the present invention. The light source 26 and light detector 28 look towards an aircraft model 34 that has been coated in pressure sensitive paint (such as that shown in FIG. 4a). The light source 26, light detector 28 and model 34 are located within a wind tunnel such that, in operation, air is blown over the model creating a varying pressure profile that reflects the aerodynamic performance of the model 34. The processor 30 is located external to the wind tunnel such that it can be accessed by an operator during operation of the wind tunnel.

In this embodiment, the light source 26 is Nd-YAG laser operating at 532 nm. However, there are many other suitable alternatives that meet the requirement of producing bright flashes of light and that can be driven at high repetition rates typically in the kHz range.

The light detector 28 of this embodiment is an avalanche photodiode 28. This type of device collects light from only a small part of the model and, as such, provides a one-dimensional profile of that part of the surface of the model. Where two-dimensional pressure profiles are required, these can be obtained simply by scanning the light source 26 and light detector's field of view across the surface of the model 34 such that it collects light from different parts of the model's surface.

The processor 30 is a personal computer and is used to control the sensor system 24. The processor 30 is linked to both the light source 26 and the light detector 28 such that signals can be sent to the light source and can be exchanged in both directions with the light detector. The processor 30 includes an analog-to-digital converter (ADC) for receiving measurements from the light detector 28. Accordingly, the processor 30 sends a signal to the light detector 28 to take a measurement of the decay curve 10 and then converts the analogue signal 32 to a corresponding digital value, thereby effectively performing a digital sampling of the decay curve 10.

The processor 30 regulates use of the sensor system 24 as follows. Once the operational conditions in the wind tunnel are met, i.e. the wind tunnel fan is up to speed and the painted model 34 is in position, an operator can command the processor 30 to capture data from the model 34. Upon this command, and before the model 34 is illuminated during each data collection run, the processor 30 sends a signal 36 to the photodiode 28 to sample the light it is receiving over a number of successive time slots and pass the values to the processor 30 via the ADC. The processor 30 then calculates the average baseline value per unit time from the digitised data. Hence, a measurement of the dark current and ambient light in the photodiode 28 is obtained and this can be used as a baseline subtraction for data taken after illumination of the model 34. Once the baseline value has been determined, the processor 30 sends a signal 38 to the light source 26 such that the light source 26 produces a flash illumination microseconds after the baseline data sampling and coincidentally sends the first of a series of signals 36 to the photodiode 28. The series of signals 36 sent to the photodiode 28 act as gate signals to start and end time intervals 40a,b of data sampling. During each time interval 40a,b, the photodiode 28 is run such that the integrated light intensity over that interval 40a,b is sampled. At the end of each time interval 40a,b, the value measured by the photodiode 28 is passed to the processor 30 via the ADC where it is digitised before being subject to data processing, such as subtraction of the baseline value, as will be described below.

Furthermore, the method described above can be performed consecutively such that when the data from the last time interval 40b has been collected, the processor 30 causes first a new baseline sampling and determination stage and then causes the light source 26 to produce a second light flash and the same data collection routine to be run as described above. This procedure can be repeated as many times as is desired. The extra data collected in this way may be used to improve statistics, i.e. to determine pressure and/or temperature by averaging a number of decay curves or may be used to obtain successive values of pressure and/or temperature where high-resolution time intervals are required.

The sensor system 24 may be operated such that the photodiode 28 samples data over many short and successive snapshots to produce a series of data points that indicate the decay curve 10 of FIG. 1. If sufficient data points are sampled, the decay curve 10 may then be fitted using standard curve-fitting techniques to derive the coefficients kₘᵢₙ, kₘₐₓ, kₚₑₐₖ and the v-factor. However, performing a curve fit for every decay curve 10 collected by the photodiode 28 is very slow and is prone to correlations. Hence, an alternative method has been devised, and will be described with reference to FIG. 6.

First, a batch of pressure sensitive paint must be calibrated before it can be used for pressure measurements, as indicated in FIG. 6 by 42. This is performed by using small samples of the pressure sensitive paint in an environmental chamber, where the baseline value is determined prior to illuminating the model and sampling whole decay curves 10 at 44 with an avalanche diode 28, i.e. illumination readings are sampled continuously via an ADC throughout the extinction of the luminescence, for a representative range of pressures and temperatures. In this example, 500 decay curves 10 were sampled at each of sixteen conditions, corresponding to 10° C. steps over the temperature range −20° C. to +50° C. for two different airflow speeds (and hence pressures on the model), as indicated at 44. The 500 curves were averaged to produce an average decay curve for each condition. However, the number of decay curves measured and the number of temperature and pressure conditions may be varied freely according to need.

The average decay curves are curve fitted at 46 to derive kₚₑₐₖ as a function of pressure and temperature, kₘᵢₙ as a function of pressure and temperature and v as a function of temperature alone (kₘₐₓ can be fixed to the value of kₚₑₐₖ, e.g. kₘₐₓ=kₚₑₐₖ/0.6). From this, a master decay curve equation (i.e. a model) can be generated at 48. Moreover, notional gates 40a,b can be found from the master decay curve equation and the integrated light intensity represented by the areas of these gated areas 40a,b calculated. Two pairs of notional gates 40a,b are used: the first pair 40a occupy the rapid extinction part 12 and so is sensitive to high decay rate sights and the second pair 40b occupy the low extinction part 14 and so are sensitive to low decay rate sights, as shown in FIG. 1. The ratio of intensities IR1 and IR2 between the pairs of gated areas 40a,b can then be calculated. The ratios will be functions of pressure and temperature (i.e. IR1(P,T) and IR2(P,T)) and they can be expressed as polynomials in pressure and temperature: these polynomials are calculated at 50 and stored in the processor.

Confidence can be placed in the above method because curve fitting decay curves showed that the linearity of the various decay rates (kₘᵢₙ, kₘₐₓ and kₚₑₐₖ) to pressure at constant temperature is excellent and because extrapolations to zero pressure were very similar and correspond to the radiative decay rate. A representative graph is shown in FIG. 5. Not only that, but when the full pressure and temperature dependency of the decay rates were derived, they were sufficiently different for the expressions to be solved for temperature and pressure. It is essentially the differing sensitivities to temperature that allow IR1(P,T) and IR2(P,T) to be solved for pressure and temperature. That, in turn, is due to differing sensitivities of kₘᵢₙ, kₚₑₐₖ and kₘₐₓ to temperature.

Where the pressure sensitive paint has already been calibrated and the polynomials determined, these polynomials may simply be retrieved from the processor 30 as indicated at 52.

With the polynomials relating the gated areas 40a,b known, the sensor system 24 can now be operated in a quick and efficient manner. With a painted model 34 placed in the wind tunnel that is in an operational condition, as indicated at 54, a quick data sampling step is performed at 56 to check data taken during the calibration process 42. At 60, the results obtained at 56 are checked against those obtained at 42 to see if they are consistent. If they are consistent, data collection can proceed as normal. If they are not consistent, the calibration data is refitted at 61 and polynomials recalculated according to steps 46, 48 and 50. The data collection then proceeds using the new polynomials.

At 62, the processor 30 is used to run the baseline averaging procedure described above, and then to produce an initial illumination flash from the light source at 56 and to produce a series of signals to send to the photodiode 28 to mark the start and end of each gate 40a,b during which the photodiode 28 will be integrating the light intensity that it receives. The gates 40a,b must match the predetermined gates 40a,b for which the polynomials have been calculated. Synchronisation is achieved by setting the peak intensity 58 in any decay curve 10 as t=0: the first gate 40a,b is set to start at least 200 ns after t=0 due to the response time of the photodiode 28 and because of its non-linear response to rapidly-changing signals. Of course, it is possible to set other positions as t=0, although the delay to the first gate should be altered accordingly.

When data has been sampled by the photodiode 28 over the four designated gated areas 40a,b at 62, the processor 30 can calculate the intensity ratios for the rapidly-decaying pair of gated areas 40a and for the gradually-decaying pair of gated areas 40a at 64. The pair of polynomials can then be solved to derive the two unknowns that they contain, namely pressure and temperature, as indicated at 66.

At this stage, the derived values of pressure and temperature are checked against threshold values at 67. Where the values exceed or are below threshold values, the data collection steps 62 and 64 are repeated, but for different gate positions. This is because at high pressures, the decay rate increase due to the increased concentration of oxygen leading to more quenching and so the decay curve shows a faster extinction: in this instance it is beneficial to have the gated areas closer to t=0. Conversely, the decay curve 10 shows a more gradual extinction for low pressures and so spacing the gated areas further away from t=0 and increasing their separation is beneficial as otherwise the gated areas 40b that are supposed to occupy the gradual extinction part 14 of the decay curve 10 may occupy the rapid extinction part 12 instead. In this embodiment, three sets of gate positions were used (and all the area ratios IR1 and IR2 are calculated for the three cases at 50) corresponding to normal conditions, low pressures and high pressures. Of course, this step may be omitted without departing from the scope of the invention and the number of sets of gate positions may be varied according to need.

With the pressure and temperature determined, either at the first instance at 66 or through a second, high-precision data collection routine at 69, the pressure at the area on the model's surface that the photodiode 28 was viewing can be found. As mentioned previously, the photodiode 28 can be scanned across the surface of the model 34 to build up a two-dimensional pressure map. The pressure values may then displayed on a monitor 33 or the like in any number of ways as indicated at 68. For example, colours or greyscale can be assigned to pressure values to produce a pressure map or a representation of the model's surface or a map, may be presented as a series of isobars across a representation of the model's surface. An example is shown in FIG. 4(b) where pressure values are represented using greyscale.

It will be readily apparent to those skilled in the art that variations to the above described embodiment are possible without departing from the scope of the invention defined in the appended claims.

For example, whilst the above embodiment describes use of the sensor system 24 in wind tunnel testing, it can be readily adapted for use in blood or ground water analysis. In these alternative applications, the end of an optical fibre is coated in pressure sensitive paint and connected to the light source 26 and light detector 28 via an optical coupler such that light from the light source 26 can pass down the optical fibre and light emitted by the paint can travel back to the light detector 28. The paint-coated end of the optical fibre is then placed within a blood or ground water sample and the method performed as described above. As will be readily apparent, the data collected by the light detector 28 will correspond to the luminescence intensity of the pressure sensitive paint and the same data analysis can be performed to extract partial pressure of oxygen in the blood or ground water (and hence the oxygen concentration).

Whilst the embodiment described herein before employs an avalanche photodiode 28 as a light detector, a charge coupled device (CCD) would be a good alternative. This type of device has the advantage that it provides a two-dimensional array of pixels that can be used to represent a two dimensional array of spot pressures on the part of the model 34 that the CCD is viewing. Furthermore, a CCD is inherently an intensity integrating device and therefore is well suited to measuring light intensities integrated over gated time intervals 40a,b. In addition, intensified detectors such as a streak camera could be used for fast gating. Fast gating is a problem in that the time intervals between gated areas may be less that the time needed to retrieve the light intensity measured by each pixel in the CCD (this essentially involves discharging a capacitor and so is determined by the time constant of the capacitor). Another way around this problem is to use more than one CCD or to divide the pixels into separate arrays, e.g. use alternate lines of pixels to measure alternate gated areas or divide the array into four quadrants, one for each gated area.

As an alternative to using an ADC to digitise data collected from the avalanche photodiode thereby effectively sampling the decay curve 10, a simpler scheme such as using a timer to collect data over a series of boxcar gates may be used. The main disadvantage of this scheme is that the position of the boxcar gates is fixed and so the flexibility to move the gated areas according to the shape of the decay curve is lost.

Two pairs of intensity ratios obtained from four gated areas 40a,b are used to obtain pressure and temperature information, but satisfactory results can be obtained by taking two ratios from three gated areas 40a,b. Conversely, more than two ratios can be taken for further accuracy. This can be achieved by taking more pairs of intensity integrations, or by calculating various combinations of ratios between a number of grated areas 40a,b.

1. A method of calibrating pressure sensitive paint comprising the steps of:
illuminating the pressure sensitive paint under a range of pressures and temperatures;
measuring the intensity of light emitted by the pressure sensitive paint following each illumination thereby measuring decay curves; and
performing a curve fit of the decay curves to the general form
$$I ( t ) = a \cdot {ⅇ}^{- {k}_{peak} t} + \frac{b}{t} ( \frac{{ⅇ}^{{k}_{min} t} - {ⅇ}^{{k}_{max} t}}{{k}_{max} - {k}_{min}} )$$
where t is time elapsed and a, b, kₚₑₐₖ, kₘᵢₙ and kₘₐₓ are determined by the curve fit.

2. A method according to claim 1, further comprising the steps of measuring the intensity of light emitted by the pressure sensitive paint prior to illumination to give a background intensity value and subtracting the background intensity value from the decay curve prior to performing the curve fit of step (c).

3. A method according to claim 1, wherein a simplified form of the equation in step (c) is used during curve fitting, namely
$$I ( t ) = {I}_{0} ( v \cdot {ⅇ}^{- {k}_{peak} t} + \frac{1 - v}{t} ( \frac{{ⅇ}^{{k}_{min} t} - {ⅇ}^{{k}_{max} t}}{{k}_{max} - {k}_{min}} ) )$$
where I₀ is the peak intensity measured and v is determined by the curve fit

4. A method according to claim 1, wherein the temperatures range extends substantially from −20° C. to +50° C.

5. A method according to claim 4, wherein the pressure sensitive paint is illuminated incrementally over the temperature range in 10° C. steps.

6. A method according to claim 1, wherein a plurality of decay curves are measured at each temperature and pressure value and the plurality of decay curves are integrated or averaged prior to curve fitting.

7. A method according to claim 5, wherein substantially 500 decay curves are measured at each temperature and pressure value.

8. A method according to claim 1, further comprising the steps of: generating a model of decay curves over the range of pressures and temperatures from the determined values of a, b, kₚₑₐₖ, kₘᵢₙ and kₘₐₓ or v, kₚₑₐₖ, kₘᵢₙ and kₘₐₓ; and calculating a polynomial relating pressures and temperatures for ratios of intensities over gated areas of the model decay curves.

9. A method according to claim 8, wherein the position of the gated areas within the model decay curves are determined with reference to the model of decay curves.

10. A method according to claim 9, wherein a first pair of gated areas are determined to occupy the rapidly-decaying portion of the model decay curves and a second pair of gated areas are determined to occupy the gradually-decaying portion of the model decay curves.

11. A method according to claim 9, wherein alternative gated area positions are determined for the model decay curves according to different pressure and temperature regimes, thereby forming an alternative polynomial.

12. A method according to claim 11, wherein three temperature regimes and one pressure regime are used.

13. A method of determining pressure comprising the steps of:
(i) illuminating a pressure sensitive paint calibrated according to claim 8;
(ii) measuring the intensity of light emitted by the pressure sensitive paint following illumination over two of the gated areas;
(iii) determining the ratio of the gated area intensities; and
(iv) determining the pressure and/or temperature from the polynomial using the ratio of the gated area intensities determined in step (iii).

14. A method according to claim 13, further comprising the steps of measuring the intensity of light emitted by the pressure sensitive paint prior to the illumination of step (i) to give a background intensity value and subtracting the background intensity value from the measurements of the gated areas prior to determining the ratio of the gated areas in step (iii).

15. A method according to claim 13, wherein intensity measurements are taken and compared against intensity measurements taken during calibration and, if the results are not consistent, a new polynomial is calculated with reference to the new intensity measurements.

16. A method according to claim 15 wherein, in step (ii), the light emitted over two pairs of gated areas is measured, in step (iii), ratios of both pairs of gated areas are determined and, in step (iv), the determination is performed using both determined ratios.

17. A method according to claim 10, wherein the first pair of gated areas occupy the rapidly-decaying part of the decay curve and the second pair of gated areas occupy the gradually-decaying part of the decay curve.

18. A method according to claim 11, wherein the pressure and/or temperature determined by reference to the polynomial is/are checked against the pressure and temperature regimes and, if the polynomial used does not correspond to the pressure and temperature regime determined, steps (ii), (iii) and (iv) are repeated using the appropriate alternative gated area positions and appropriate alternative polynomial.

19. A method according to claim 13, comprising the step of illuminating a model coated in pressure sensitive paint that is positioned in a wind tunnel.

20. A method according to claim 19, wherein the intensity of light emitted from a plurality of portions of the model are measured and the pressure at each portion is determined.

21. A computer program comprising program instructions for causing a computer:
to receive data in the form of decay curves from a pressure sensitive paint measurement apparatus; and
to perform a curve fit of the decay curves to the general form
$$I ( t ) = a \cdot {ⅇ}^{- {k}_{peak} t} + \frac{b}{t} ( \frac{{ⅇ}^{{k}_{min} t} - {ⅇ}^{{k}_{max} t}}{{k}_{max} - {k}_{min}} )$$
where t is time elapsed and a, b, kₚₑₐₖ, kₘᵢₙ and kₘₐₓ are determined by the curve fit.

22. A computer program according to claim 21, further causing the computer to perform the curve fit to a simplified form of the equation of claim 21, namely
$$I ( t ) = {I}_{0} ( v \cdot {ⅇ}^{- {k}_{peak} t} + \frac{1 - v}{t} ( \frac{{ⅇ}^{{k}_{min} t} - {ⅇ}^{{k}_{max} t}}{{k}_{max} - {k}_{min}} ) )$$
where I₀ is the peak intensity measured and v is determined during the curve fitting.

23. A computer program according to claim 21, further causing the computer: to generate a model of decay curves from the determined values of a, b, kₚₑₐₖ, kₘᵢₙ and kₘₐₓ or v, kₚₑₐₖ, kₘᵢₙ and kₘₐₓ; and to calculate a polynomial relating pressures and temperatures for ratios of gated areas of the model decay curves.

24. A computer program according to claim 23, further causing the computer to determine the position of the gated areas with reference to the model of decay curves.

25. A computer program according to claim 23, further causing the computer:
to receive data corresponding to measurements from the gated areas;
to determine the ratio of intensities from the gated areas; and
to determine the pressure and/or temperature from the polynomial.

26. A carrier having thereon a computer program according to claim 21.

27. A computer when programmed with the computer program of claim 21.

28. A pressure sensitive paint measurement apparatus comprising a light source for illuminating the pressure sensitive paint, a light detector for measuring the light emitted by the pressure sensitive paint and the computer of claim 27 when programmed to receive data in the form of decay curves from the light detector.

29. An apparatus according to claim 28, wherein the light source is a Nd-YAG laser.

30. An apparatus according to claim 28, wherein the light detector is an avalanche photodiode.

31. An apparatus according to claim 28 further comprising an analogue-to-digital converter operable to digitise the data provided by the light detector.

32. An apparatus according to claim 28 when dependent upon claim 25, further comprising a display and wherein the computer is programmed to cause the display to show the determined pressure and/or temperature.

33. An apparatus according to claim 28, further comprising a model bearing the pressure sensitive paint and a wind tunnel.

34-37 (canceled).
